(19) United States
(12) Patent Application Publication
(10) Pub. No.: US 2003/0135457 A1
(43) Pub. Date: Jul. 17, 2003

(54) Method and apparatus for providing online financial account services

(76) Inventors: Whitney Hilton Stewart, Cave Creek, AZ (US); Robert L Hill, Mill Creek, WA (US)

Correspondence Address: MICHAEL BEST & FRIEDRICH, LLP, 100 E WISCONSIN AVENUE, MILWAUKEE, WI, 53202, US

(21) Appl. No.: 10/221,011

(22) PCT Filed: Nov. 30, 2000
(86) PCT No.: PCT/US00/42416

(51) Int. Cl. G06F 17/60

(52) U.S. Cl. 705/39

(57) ABSTRACT

A fully-integrated and substantially-automated system and method for providing wholly-integrated account services over the Internet by which a consumer can establish a financial account electronically, without physically visiting the financial institution, and a system for effecting the method. The system and method provide the ability to perform real-time or near real-time demand deposit account openings through the Internet, to automate funding of the account products chosen by the customer, and for fulfillment support of the account products.

### RELATED APPLICATIONS

This application claims the benefit under 35 U.S.C. § 119 of U.S. Provisional Application No. 60/168,272, entitled METHOD AND APPARATUS FOR USE IN ENTERING FINANCIAL DATA INTO AN ELECTRONIC DEVICE, filed on Dec. 1, 1999; U.S. Provisional Application No. 60/168,276, entitled METHOD AND APPARATUS FOR AN ELECTRONIC CHECK PAYMENT SYSTEM, filed on Dec. 1, 1999; U.S. Provisional Application No. 60/168,273, entitled METHOD AND APPARATUS FOR PROVIDING ONLINE FINANCIAL ACCOUNT SERVICES, filed on Dec. 1, 1999; U.S. Provisional Application No. 60/209,476, entitled METHOD AND APPARATUS FOR FUNDING A FINANCIAL ACCOUNT, filed on Jun. 5, 2000; and U.S. Provisional Patent Application No. 60/209,446, entitled METHOD AND APPARATUS FOR PROVIDING ONLINE FINANCIAL ACCOUNT SERVICES, filed on Jun. 5, 2000, which are all incorporated herein by reference.

### FIELD OF THE INVENTION

The invention relates to the provision of financial account services over the Internet and, particularly, to a method and apparatus for opening demand deposit accounts via the Internet.

### BACKGROUND OF THE INVENTION

In the usual course of opening a financial account, and particularly a demand deposit account, a consumer currently needs to physically visit the bank, savings and loan, or credit union of choice. The consumer provides sufficient personal information to meet the financial institution's needs, e.g., for risk assessment and identity verification. The consumer must also provide funds to be used in opening the account. The consumer is presented with and chooses between various savings and checking account options. The accounts are then “opened” using the consumer's personal information and funds, and the consumer signs a signature card to be used to confirm later transactions. Some accounts can be opened remotely, but these usually involved an exchange of documents and funds by conventional mail or courier.

Once an account is established, the consumer can conduct transactions using the account either in person at the financial institution or through a number of remote means such as automatic teller machines, telephone, or the Internet.

### SUMMARY OF THE INVENTION

The problem with current practices is that the establishment of an account at a financial institution must be done either in person or by the transfer of documents and funds by conventional mail or courier. In particular, the major points of difficulty in establishing an account remotely are threefold: obtaining initial funding, obtaining a signature card, and providing the consumer with account options without requiring the consumer to visit the financial institution.

Accordingly, the invention described herein provides a method by which a consumer can establish a financial account electronically, without physically visiting the financial institution, and a system for effecting the method. More particularly, the invention provides a fully-integrated and substantially-automated system and method for providing wholly-integrated account services over the Internet.

The system and method provide the ability to perform real-time or near real-time demand deposit account openings through the Internet. The Internet is used first to attract potential customers to the financial institution's site, where the potential customers can learn about the products offered by the financial institution. The potential customer applies on-line, providing personal information to the financial institution such as is necessary to determine whether or for which products the customer will be approved. An automated system acquires this predictive information, interacts with established debit, credit, and other databases, and dynamically approves or denies the customer's application for a demand deposit account product. The consumer can also be presented with a variety of products based on the customer's needs and qualifications.

The invention also provides a method for automated funding of the account products chosen by the customer and for fulfillment support of the account products.

The invention has the advantage of attracting potential customers through channels previously unavailable to financial institutions. The invention also has the advantage of providing customers with a simple and flexible method of opening a new account consistent with other Internet-based transactions, without having to visit the financial institution of choice. Consequently, the pool of potential customers is not limited to those in the geographical area of the financial institution. Rather, any customer with access to the Internet can open an account.

The invention also has the advantage of providing a demand deposit account opening solution that is both low cost and low risk.

The invention also has the advantage of providing a real-time solution to the problem of opening accounts remotely and allows customers to open and fund an account in a short time over the Internet.

Other features and advantages of the invention will become apparent to those skilled in the art upon review of the following detailed description, claims, and drawings.

### BRIEF DESCRIPTION OF THE DRAWINGS

FIG. 1 is a flow diagram graphically showing a system embodying the invention.

FIG. 2 is a flow diagram graphically showing the process of the system illustrated in FIG. 1.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION OF THE PREFERRED EMBODIMENT

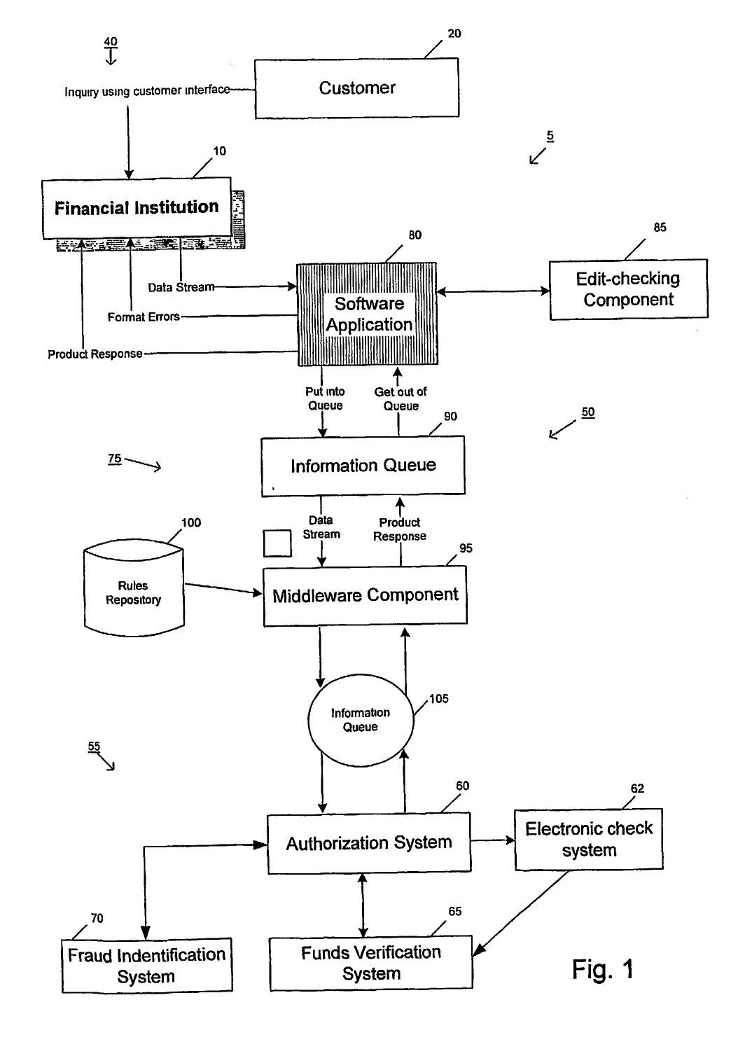

A method and an apparatus embodying the invention are described herein. FIG. 1 illustrates a system 5 embodying the invention. The system 5 provides a data stream interface to allow a financial institution 10 to process an integrated demand deposit account opening decision and an account funding transaction. The financial institution 10 interacts with a customer 20 via the financial institution's web site via the process described herein. In this description, a financial institution 10 can be a retail bank or savings and loan, an Internet-based bank, or any other type of financial or investment services company offering deposit-based services. A deposit account can be a checking or savings account, a certificate of deposit, a money market account, or any other suitable financial account.

In general terms, the system 5 includes a first interface 40 between a potential customer 20 (hereinafter referred to as a customer 20) at a remote location and a financial institution 10, and a second interface 50 between the financial institution 10 and existing back-end tools or filters 55 used to evaluate the customer 20. The first interface 40 consists primarily of the financial institution's web site, the applications associated with the web site, and the customer's remote capabilities. The second interface 50 is provided using software tools. The interfaces 40, 50, the web site, the customer's access, and the back-end tools 55 are all computer-based and capable of communicating with each other as is commonly known in the art. The interfaces 40, 50 provide security features in the form of encryption that is preferably router-based, including route, communication, and application layer security.

The financial institution 10 provides, on a web site, information related to demand deposit accounts and other services offered by the financial institution 10. A potential customer 20 interested in opening a demand deposit account electronically accesses the financial institution web site and provides data to the financial institution 10 via the first interface 40. Because the application process is primarily web-based, a customer 20 may access the financial institution 10 electronically from virtually any remote location.

The web site is able to handle data entry errors (e.g., format errors) and technical errors. The web site can process data in a single data stream or in multiple data streams, and can process data in virtually any format presented by the customer 20. The customer data is transmitted electronically to the financial institution 10, which uses the data to automatically evaluate the customer 20. Customer evaluation is performed primarily by existing back-end tools 55, some of which are summarized as follows.

An authorization system 60 is used to validate consumer identity and to assess customer risk, unique financial product usage, demographic knowledge at a household-level-assessment, and cross-sell qualification. An example of such a system is the QUALIFILE-brand authorization system. QUALIFILE is a service mark registered in the name of ChexSystems, Inc., a wholly-owned subsidiary of eFunds Corp. The authorization system 60 uses a logistic-regression model to predict the likelihood of financial (and particularly debit) account-related abuse. The authorization system 60 uses customer data such as the customer's social security number, driver's license number, and address to calculate the risk that an account will be closed for abuse at a later date, and delivers to the financial institution 10 the action to take on a deposit account inquiry based on predefined criteria set up by the financial institution 10. The authorization system 60 also calculates the cross sell opportunity for additional debit and/or credit products for a consumer. Based on a credit score and key demographic variables determined by the authorization system 60, the authorization system 60 can recommend which other products, if any, to offer to the customer 20.

An automated search routine within the authorization system 60 also checks customer data against restricted lists published by the United States Treasury Department Office of Foreign Assets Control (OFAC) to maintain OFAC compliance. This search includes enhanced name/foreign translation mapping to provide matching capabilities with low false-positive responses.

The authorization system 60 also communicates with an electronic check system 62. The electronic check system 62 captures customer data 20 and processes the data to determine whether the new account may be electronically funded.

A funds verification system 65 uses customer data to provide a check-based funding option allowing a customer 20 to make initial deposits during Internet account openings. An example of such a system is the SECURECHECK-brand funds verification system. SECURECHECK is a service mark of the Community Currency Exchange Association of Illinois, Inc. Funds are electronically transferred from the customer's existing checking account at the customer's previous bank to the financial institution's custodial account using automated clearing house (ACH) transactions. The service provided by the funds verification system 65 is enhanced by a robust transactional decisioning layer including information from a check verification system such as the SHARED CHECK AUTHORIZATION NETWORK (SCAN) check verification system, a product of Deluxe Payment Protection Systems, Inc., a wholly-owned subsidiary of eFunds Corp. The service also uses information from Primary Payment Systems, Inc. (PPS), and other proprietary data sources and analyses. Results from the electronic check system 62 are transferred to the funds verification system 65.

More specifically, the data includes customer-entered check data for a demand deposit account located at the financial institution 10. The data is entered using magnetic ink character recognition (MICR) character recognition software, an example of which is shown and described in U.S. patent application serial No. 60/168,272, which is incorporated herein by reference. The customer 20 provides a primary name, an address, a home telephone number, a check number, a check amount, a check account number, and a MICR line. The MICR line characters include decimal numbers from 0 to 9 and MICR symbols. The MICR symbols allow the MICR reader to distinguish among the different fields in the MICR line. A first MICR symbol is called an “on-us” indicator. The issuing financial institution 10 (i.e., the financial institution 10 on which the check is drawn) determines the content of the “on-us” field. Usually, the “on-us” field identifies the account number of the account on which the check is drawn. However, other information can be disclosed in the “on-us” field and more than one on-us field can be added to a paper check. A second MICR symbol is called a transit symbol. The transit symbol is always used in pairs on both sides of a transit or routing number. The routing number, which is 9 digits long, identifies the financial institution 10 on which the check is drawn. A third MICR symbol is called a dash symbol. The dash symbol is used as a separator within the “on-us” field and can be used in whatever way the issuing financial institution 10 wants to use it. Other information may be entered (e.g., a joint name or a second telephone number).

The customer 20 enters the MICR line data as seen on a financial document (e.g., a physical check) directly. The customer 20 simply inputs all of the MICR numbers and symbols shown on the MICR line. This results in fewer errors because the customer 20 is not required to distinguish among the different fields in the MICR line.

The entry system provides basic typographical data validation routines at a server. The typographical validation routines help prevent the financial institution 10 from declining funding due to typographical errors by a customer 20. In other words, the typographical validation routines will provide a first level of data validation before the MICR code line is further processed for funding of an account. The entry system also includes a software program to generate computer recognizable financial data characters in response to the data from the customer 20.

After reviewing the entered information, the customer 20 authorizes the funds transfer. The data entered by the customer 20 is transmitted from the customer 20 to the financial institution 10. The financial institution 10 may analyze or modify the data, analyze or modify a portion of the data or, preferably, transmit the data unchanged.

Once the financial institution 10 receives the data, the financial institution 10 validates the data by providing the data to one or more software modules or filters. The financial institution 10 provides the entered MICR data to a Primary Payment Systems (PPS) database filter. The PPS database filter ensures the account number entered by the customer 20 is not from an account that is either closed or contains serious insufficient finds warnings.

The filters as described are included as illustrative examples of filters that can be used in the system. Filters, including filters that have not been described, can be added to or removed from the system as needed. Some of these additional filters are set forth below.

A filter that validates the association or ownership between entered financial data with data in a check circulation database. The filter attempts to find a match between the entered MICR line and a MICR line in the check circulation database. Matching the entered MICR line data with a MICR line in the check circulation database validates the presence of a relationship between the entered check data with a check in circulation (i.e., printed).

A receiving depository financial institution (RDFI) filter that receives the entered MICR line from the system 5 and ensures that the MICR line entered by the customer is from a member of one of the automated clearing house networks.

A maximum authorization limit (MAL) filter that receives the entered financial data from the system 5 and ensures that the entered currency amount does not exceed a threshold level set by a financial institution.

A return retail filter that receives the entered financial data from the system 5 and ensures that the entered MICR line is not a MICR line from an account that has previously issued a dishonored check.

A MICR ID validation filter that receives the entered financial data from the system 5 and verifies the ABA format by ensuring that the entered account number has more than two digits, and determines whether the entered account is an ABA assigned account.

A hot file filter that receives the entered financial data from the system 5 and enables the financial institution to decline transfer of funds from MICR numbers that will result in a declination response.

A permanently protected account (PPA) database filter that receives the entered financial data from the system 5 and validates that the entered MICR number is not related to a check in the PPA database. Examples of MICR numbers in the PPA database include VISA, MasterCard or Discover Card checks, traveler's checks and money orders.

A public or private velocity measurement filter that receives the entered financial data from the system 5 and tracks the activity level of the account based on pre-defined criteria established by a financial institution. For example, the financial institution may define criteria such that the customer cannot transfer funds to the electronic account from the same source in a 24 hour period. Out-of-pattern activity or excessive activity results in a declination response.

An account closure filter that receives the entered financial data from the system 5 and verifies that the entered MICR line is not from an account that was closed for cause (i.e., non-sufficient funds).

A lost or stolen account filter that receives the entered financial data from the system 5 and compares the entered MICR line with MICR lines that have been reported lost by, or stolen from, the account-holder.

In addition, a historical database includes records of each funding transaction performed by the system 5. All transaction data is stored and used for positive and negative verification filters on subsequent transactions. Additionally, the historical database is used to create new filters and to provide a record for a financial institution. The records of the historical database include the MICR line, currency amount, check number and result of the funding transaction. The historical database records may also include additional data. For example, the historical database may track and store data for a velocity measurement filter, which records activity level data for a checking account.

After the data is checked for accuracy, the entered MICR line is converted into a format capable of being posted at the ACH. The funding transaction is presented to the ACH and funds are transferred to an escrow account for the financial institution 10 to transfer funds from the escrow account into the newly-opened account. The funding transaction presented to the ACH includes the MICR data in the appropriate ACH format.

A fraud identification system 70 is a neural-network decisioning model that predicts the likelihood of identity manipulation or fraud. An example of such a system is the FRAUDFINDER-brand fraud identification system from ChexSystems, Inc., a wholly-owned subsidiary of eFunds Corp. The fraud identification system 70 uses customer data to provide a score on a customer inquiry that indicates the fraud risk level involved with doing business with the customer 20. The fraud identification system 70 also provides identity manipulation and predictive fraud modeling, and helps to identify inconsistent, inaccurate, and fraudulent information provided by the customer 20. The fraud identification system 70 also has the ability to provide fraud attributes on a real-time basis.

For the second interface 50, a combination of software tools 75 has been developed to communicate and coordinate information between the financial institution 10 and the various back-end tools 55. The combination of tools 75 receives an inquiry from a financial institution 10 via the Internet or other communications methods for processing, and determines an inquiry's format and the format needed for a reply based upon the name of the calling transaction. The combination of tools 75 also changes the inquiry format to one suitable for accessing processing systems, and converts the response from those systems to the appropriate format for the customer 20. Finally, the combination of tools 75 returns a response via the Internet or other communications methods to the financial institution 10.

Processing of information between the financial institution 10 and the back-end tools 55 is coordinated by a computer-based software application 80. The software application 80 receives an input data stream from the financial institution's web interface. The inquiry is passed to an edit-checking component 85 that performs field and record-level edits. The edit-checking component 85 recognizes any formatting errors in the input data stream (e.g., a dash in a Social Security number) and returns those errors to the financial institution's web interface for correction. Once all edit checks pass successfully, the inquiry is put on an information queue 90.

The information queue 90 provides an interface between the software application 80 and a middleware component 95. The middleware component 95 parses incoming messages from a number of sources and then, based on content, transforms and routes the messages to the appropriate output queues in the appropriate formats for delivery to processing systems or to the software application 80. The middleware component 95 maintains generic data flows and integrates a funds verification system inquiry and response with an authorization system inquiry and response. The middleware component 95 also coordinates input from a routing and reformatting rules repository 100.

The rules repository 100 stores generic routing and transformation rules such as metadata in a relational database. The repository 100 centralizes the operation and location of business rules, and formats product response data streams to the required format for web presentation.

More specifically, the middleware component 95 communicates through an information queue 105 with the back-end tools 55 including the authorization system 60, the funds verification system 65, and the fraud identification system 70. The middleware component 95 transmits information to each of the back-end tools 55, and then receives product responses from each of the back-end tools 55. The middleware component 95 passes these responses back to the software application 80 through an information queue 90. The software application 80 returns product information from the information queue 90 to the financial institution's web interface, where a response is prepared for presentation to the customer 20.

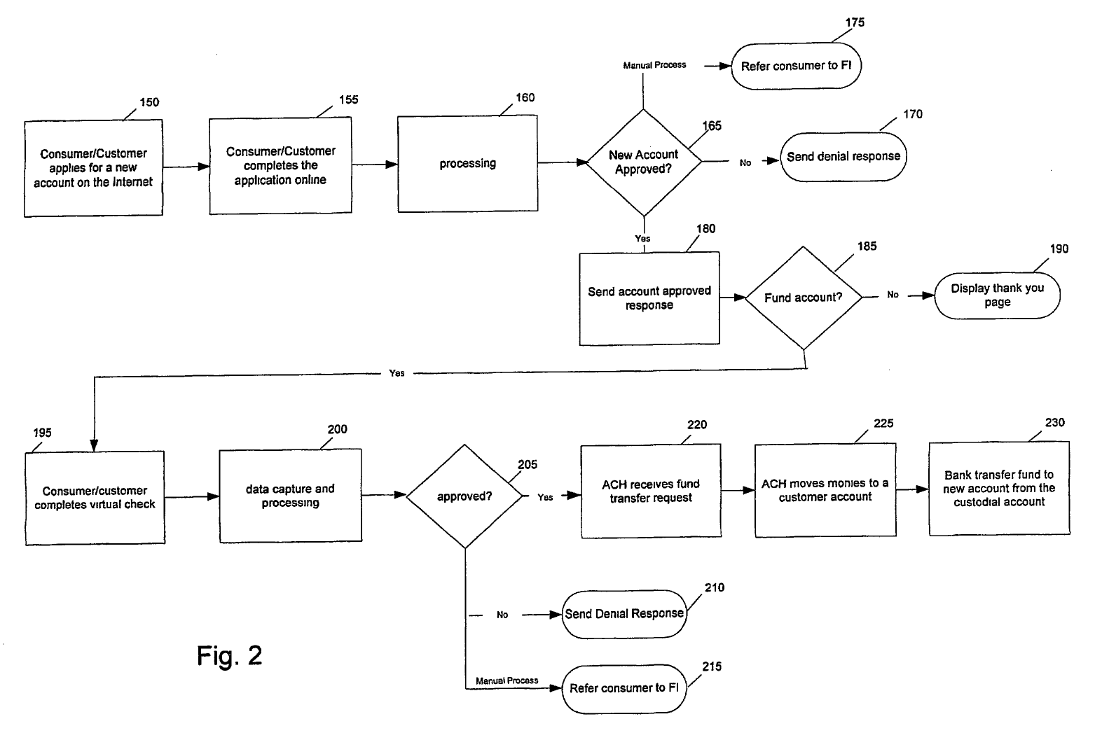

The process followed in approving and funding a new account is best illustrated in FIG. 2. At the web site of the financial institution 10, the financial institution 10 provides an application or form 150 to be completed 155 by a potential customer 20 interested in opening a demand deposit account. The online form 150 is designed to elicit customer data sufficient to primarily evaluate whether to offer the customer 20 an account. The data includes name, current and previous address, Social Security number, driver's license information, date of birth, home and business telephone numbers, and e-mail address. Because the application process is web-based, a customer 20 may access the financial institution's web site and form 150 from virtually any remote location.

Data from the customer 20 is transmitted electronically and automatically to the back end tools 55 for evaluation 160. Using results from the authorization, funds verification, and fraud identification back-end tools 55, the system 5 determines whether the new account is approved 165. For example, the back-end tools 55 return a risk score for the customer 20. The risk score is an indication of the likelihood that an account will be closed for abuse at a later date. This score is compared to an allowable risk level set by the financial institution 10 to determine whether an account is approved for that customer 20. If the account is not approved, a response indicating denial 170 is sent to the customer 20 at the web site. If any abnormalities arise during the processing, such as insufficient data, a response is sent to the customer 20 at the web site indicating that the customer 20 should contact the financial institution 10 for further action 175. The system 5 is also capable of returning an error message to the customer 20 if the authorization or funds verification back-end tools 55 are unavailable.

If the account is approved, the financial institution's web site uses further information provided by the authorization system 60 to determine the cross-sell opportunity for additional debit and/or credit products for the customer 20. Based on a credit score and key demographic variables determined by the authorization system 60, the financial institution 10 determines which other products, if any, to offer to the customer 20. The financial institution web site then returns a response indicating approval 180 to the customer 20 and extends an offer of any other products for which the customer 20 is approved. The customer 20 then accepts the terms and conditions of whatever offers are desired and sends that information back to the financial institution 10 and the software application 80, or declines all of the offers.

Once the customer 20 has accepted at least one offer of an account, the account must be funded 185. The customer 20 decides whether to fund the account manually by conventional methods, or to continue with the online process. If the customer 20 decides to end the process, the web site displays a thank you page 190 and the transaction ends. If the customer 20 decides to continue with the process, the account must be funded. Electronic funding of accounts aids in avoiding account abandonment due to lack of funding.

To fund the account, the web site presents the customer 20 with a virtual check to complete 195. The customer 20 completes the check 195 by adding data including the amount with which to fund the account, and data related to the source of funds, such as the identifying (i.e., MICR) numbers associated with the customer's financial account from which the funds will be drawn.

As with the other customer data, the check information is confirmed by the edit-checking component 85 (see FIG. 1) and the electronic check system 62 (see FIG. 1). The electronic check system 62 captures the data entered by the customer 20 and processes the data 200 (see FIG. 2) to determine whether the virtual check is approved 205. If the account is not approved, a response indicating denial 210 is returned through the previously-described channels to the customer 20 at the web site. If any abnormalities arise during the processing, such as insufficient data, a response is sent to the customer 20 at the web site indicating that the customer 20 should contact the financial institution 10 for further action 215. Finally, if the account is approved, a response indicating approval is sent to the customer 20 at the web site.

When the account is approved, the electronic check system 62 (see FIG. 1) contacts the ACH with a fund transfer request 220 (see FIG. 2), similar to the way in which a paper check would be used. In response to the request, ACH “moves” or transfers money to a custodial account 225 associated with the financial institution 10. The financial institution 10 then “moves” the money from the custodial account to the new account 230.

Once the new account is open, the customer 20 can be prompted to order checks, cards, and other products related to the account. With respect to other products, the customer 20 decides which products that are offered by the web site to select. For each point at which the customer 20 makes a decision, the system 5 re-displays customer-entered data for review and validation by the customer 20 prior to submitting the data to the system 5.

Information generated by the authorization and funds verification systems 60, 65, as well as consumer data, inquiry response information, transaction date and time, and transaction error messages, are provided to the financial institution 10. The system 5 provides reporting and auditability on transactions passing through the system 5. The system 5 also provides the ability to support 24-hours-per-day systems transactions with the exception of planned maintenance outages, of which the financial institution 10 will be given advanced notice. The system 5 supports the ability to complete an account opening and funding using primary and/or secondary signer information as required by customer qualifications.

In operation (see FIGS. 1 and 2), from the viewpoint of a customer 20, a customer 20 seeking to open and fund a new account online through a financial institution 10 is directed to the web site of the institution by web-based advertising or other links, by a web search engine, or by directly entering the site's URL address in a web browser. The web site provides information related to accounts and other services offered by the institution.

Within the web site, the customer 20 is directed to the online form. The customer 20 then applies for the new account 150 on the Internet by completing the form online 155. The completed online form is transmitted electronically to the financial institution 10.

Data from the application is automatically sent from the financial institution 10 through the second interface 50 to the authorization, electronic check system, funds verification, and fraud identification tools 55. These tools 55 act on the information, and return their responses through the second interface 50 to the financial institution web site 165, where a response is returned to the customer 20. If the response is positive 180, the customer 20 can fund the new account from a current account 195, and can decide whether to accept any further products that are offered.

With the exception of the input provided by the customer 20, the entire process proceeds without human intervention. The system 5 elicits data from the customer 20, and acts on that data to open and fund a new deposit account.

Various features of the invention are set forth in the following claims.

What is claimed is:

1. A method of remotely opening a demand deposit account with a financial institution, the method comprising the acts of:
receiving electronically demand deposit account application data from a remote customer;
processing the application through at least one filter to assess the risk to the financial institution of accepting the application;
establishing the demand deposit account electronically based on data provided in the application; and
transferring funds to the demand deposit account electronically.

2. The method of claim 1, further comprising the act of determining appropriate account offerings based on demographic data provided in the application.

3. The method of claim 1, further comprising the act of cross-selling products to the customer.

4. The method of claim 1, further comprising the act of allowing the customer to choose between offered account products.

5. The method of claim 1, wherein the processing act further includes the act of generating a risk number to quantify the level of risk to the financial institution of accepting the customer.

6. The method of claim 5, further comprising the act of comparing the risk number to an acceptable risk value set by the financial institution.

7. The method of claim 1, further comprising the act of checking the data against restricted lists published by the Office of Foreign Assets Control (“OFAC”) to maintain OFAC compliance.

8. The method of claim 1, further comprising the act of electronically providing a demand deposit account application to the remote customer for the customer to complete.

9. A method of remotely opening a demand deposit account with a financial institution, the method comprising the acts of:
receiving electronically demand deposit account application data from a remote customer;
processing the application through at least one filter to assess the risk and generate a risk number to quantify the level of risk to the financial institution of accepting the application;
comparing the risk number to an acceptable risk value set by the financial institution;
establishing the demand deposit account electronically based on data provided in the application; and
transferring funds to the demand deposit account electronically.

10. The method of claim 9, further comprising the act of determining appropriate account offerings based on demographic data provided in the application.

11. The method of claim 9, further comprising the act of cross-selling products to the customer.

12. The method of claim 9, further comprising the act of allowing the customer to choose between offered account products.

13. The method of claim 9, further comprising the act of checking the data against restricted lists published by the Office of Foreign Assets Control (“OFAC”) to maintain OFAC compliance.

14. The method of claim 9, further comprising the act of electronically providing a demand deposit account application to the remote customer for the customer to complete.

15. An automated system for remotely opening a demand deposit account with a financial institution, the system comprising:
an automated computer-based program stored in the system to assess the risk of accepting a customer application using data provided in the application;
an automated computer-based program stored in the system for establishing a demand deposit account using data provided in the application; and
a computer-based program stored in the system for electronically transferring funds into the account.

16. The system of claim 15, further comprising an automated computer-based program stored in the system for determining appropriate account offerings based on demographic data provided in the application.

17. The system of claim 15, further comprising an automated computer-based program stored in the system for cross-selling products to the customer.

18. The system of claim 15, further comprising an Internet-based selection scheme allowing the customer to choose between offered account products.

19. The system of claim 15, wherein the automated computer-based program to assess the risk of accepting the application generates a risk number to quantify the level of risk to the financial institution of accepting the customer.

20. The system of claim 19, further comprising an automated computer-based program stored in the system to compare the risk number to an acceptable risk value set by the financial institution.

21. The system of claim 15, further comprising an automated computer-based program stored in the system to check the data against restricted lists published by the Office of Foreign Assets Control (“OFAC”) to maintain OFAC compliance.

22. The system of claim 15, further comprising a computer for hosting a remotely accessible demand deposit account application accessible to the customer.

23. An automated system for remotely opening a demand deposit account with a financial institution, the system comprising:
an automated computer-based program stored in the system to assess the risk of accepting a customer application using data provided in the application by generating a risk number to quantify the level of risk;
an automated computer-based program stored in the system to compare the risk number to an acceptable risk value set by the financial institution;
an automated computer-based program stored in the system for establishing a demand deposit account using data provided in the application; and
a computer-based program stored in the system for electronically transferring funds into the account.

24. The system of claim 23, further comprising an automated computer-based program stored in the system for determining appropriate account offerings based on demographic data provided in the application.

25. The system of claim 23, further comprising an automated computer-based program stored in the system for cross-selling products to the customer.

26. The system of claim 23, further comprising an Internet-based selection scheme allowing the customer to choose between offered account products.

27. The system of claim 23, further comprising a computer-based program stored in the system for ordering checks electronically.

28. The system of claim 23, further comprising an automated computer-based program stored in the system to check the data against restricted lists published by the Office of Foreign Assets Control (“OFAC”) to maintain OFAC compliance.

29. The system of claim 23, further comprising a computer for hosting a remotely accessible demand deposit account application accessible to the customer.
